(19) United States
(12) Patent Application Publication
(10) Pub. No.: US 2023/0160778 A1
(43) Pub. Date: May 25, 2023

(54) SYSTEMS AND METHODS FOR MEASUREMENT OF OPTICAL VIGNETTING

(71) Applicant: Motional AD LLC, Boston, MA (US)

(72) Inventors: Yew Kwang Low, Singapore (SG); Nijumudheen Muhassin, Pittsburgh, PA (US); Jayesh Dwivedi, Pittsburgh, PA (US)

(21) Appl. No.: 17/455,779

(22) Filed: Nov. 19, 2021

(51) Int. Cl. G01M 11/02

(52) U.S. Cl. CPC G01M 11/0221; G01M 11/0207

(57) ABSTRACT

Provided are systems and methods for measurement of optical vignetting, which can include causing a selective emitter array to emit at least one beam of light through an off-optical axis field position of a lens assembly, receiving, at a photo sensor array, an off-axis spot based at least in part on the emitted at least one beam of light, determining a size of the off-axis spot, and determining an off-axis F-Number of the lens assembly associated with the off-optical axis field position based on comparing the determined size of the off-axis spot with a size of an on-axis spot. Systems and computer program products are also provided.

### BACKGROUND

The present application is directed to optical systems, including camera systems having lens assemblies. Some embodiments of the present application relate to methodologies and systems for evaluating vignetting effects and/or determining an effective F-number at various field positions and viewing angles for lens assemblies.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5 is a diagram representing how light passes through a lens assembly at different viewing angles to illustrate the effects of optical vignetting;

FIG. 6 is a diagram illustrating optical vignetting at different angles;

FIG. 7 is a diagram illustrating an example system and methodology for measurement of optical vignetting, including a selective emitter array, a lens assembly to be tested, and a photo sensor array;

FIG. 8 is a diagram showing various example field positions of a lens assembly to be tested for optical vignetting;

FIG. 9 is a flow chart depicting an example methodology or process for measurement of optical vignetting of a lens assembly;

FIG. 10 is a flow chart depicting another example methodology or process for measurement of optical vignetting of a lens assembly; and

FIG. 11 is a flow chart depicting another example methodology or process for measurement of optical vignetting of a lens assembly.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

General Overview

In some aspects and/or embodiments, systems, methods, and computer program products described herein include and/or implement methodologies for evaluating a lens assembly to determine and/or measure vignetting effects and/or an effective F-number at various field positions and viewing angles of the lens assembly. In some implementations, the lens assembly can be selected for or configured for use in a camera system of an autonomous system, such as an autonomous system of a vehicle that is configured to provide the vehicle with autonomous capability (e.g., to be partially or fully operated without human intervention including, without limitation, fully autonomous vehicles, highly autonomous vehicles, and/or the like). Because, in some instances, autonomous systems make determinations based at least in part on the output of associated camera systems, it can be highly important to test and understand the nature and extent of vignetting effects the lens assemblies used therein. Making efforts to improve the quality of the lens assemblies and camera systems can increase the accuracy and predictability of an associated autonomous system and improve safety.

For example, in a camera system, the aperture of a lens assembly may change at different viewing angles of the lens assembly, such as moving from an on-axis (e.g., center) position to an off-axis (e.g., a corner) position of the field of view of the lens assembly. This can result in optical vignetting and/or variation in the F-number of the lens at different positions across the field of view. For some lens assemblies, such variation can be quite significant due to poor design or due to selection of lens elements solely based on their lower cost. This can result in a large performance drop for the lens assembly, especially on the outer field (e.g., at positions greater than 0.5F). Accordingly, it can be important to measure and test the effects of optical vignetting and the F-number of lens assemblies at different positions across the field of view prior to their inclusion in autonomous systems. The present application provides systems and methodologies for such testing and measurement.

In some examples, a light source, such as a selective emitter array, emits light through an off-optical axis field position of a lens assembly. A photo sensor array receives the light after it passes through the lens assembly and detects a corresponding off-axis spot based on the light. The size of the off-axis spot can be determined, and an off-axis F-Number of the lens assembly associated with the off-optical axis field position can be calculated based on comparing the determined size of the off-axis spot with a size of an on-axis spot. In some examples, a degree of variation between the determined size of the off-axis spot and the size of an on-axis spot of the lens assembly is compared with a threshold and lens assembly is rejected when the degree of variation exceeds a threshold. The described methodologies for measuring vignetting can be used for quality control of the lens assembly.

The systems, methods, and computer program products for measurement of optical vignetting described herein can provide, in various embodiments, one or more of the following advantages. Some advantages of the technology include the ability to measure the F-number and/or the effects of optical vignetting at different positions across a field of view of a lens assembly. This can include both on-optical axis positions and off-optical axis positions of varying degree, including both near and far field positions. The methods and systems may be used to measure any field position on the lens assembly, which can allow for complete testing of the lens assembly.

In some implementations, the light source(s) (e.g., a selective emitter array) used during or with the processes and techniques described herein are configured to allow for flexibility in determining the position of the field of view of the lens assembly where the F-number is being measured. For example, different light sources can be activated at different positions and/or times to measure the effects of optical vignetting and/or the F-number at different positions. In some instances, the measuring system(s) described herein may also be configured for measuring the F-number for different wavelengths of light. The use of these methods as a quality control step may help to ensure the lens assembly being used is of sufficient quality, for example, for use in an autonomous system of a vehicle.

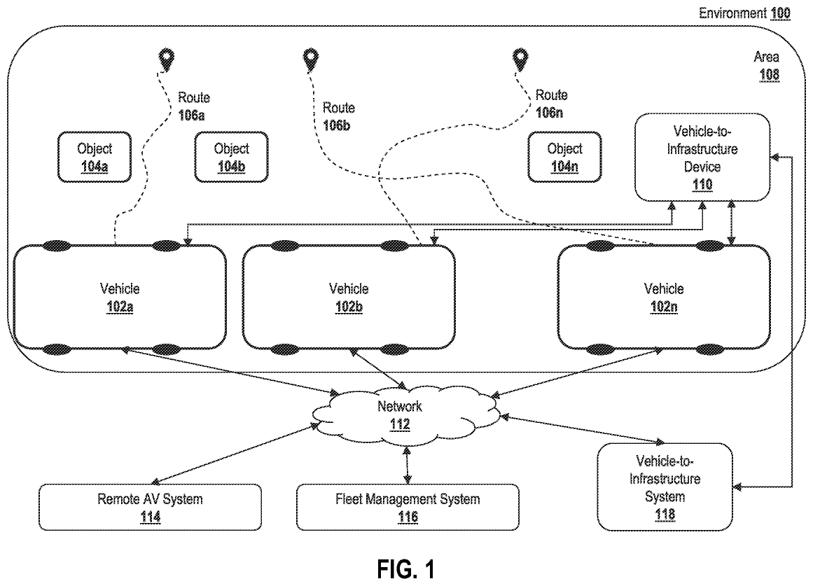

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

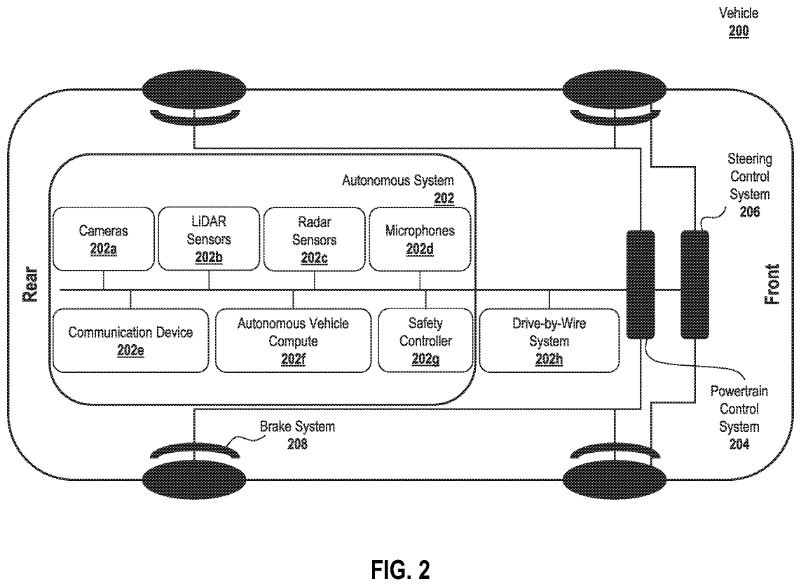

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

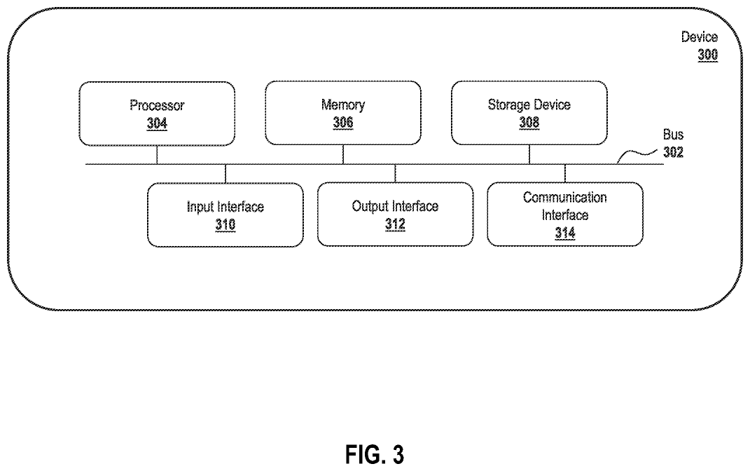

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible. Lens assemblies associated with camera 202a may, during a quality control or verification step, be tested using the systems or methods for measuring optical vignetting described herein to ensure that they are of sufficient quality for use in the autonomous system 202. Verifying that the lens assemblies meet certain standards can help to improve the quality and safety of the autonomous system 202a.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one V2I device 110, at least one device of remote AV system 114, at least one device of fleet management system 116, at least one device of V2I system 118, at least one device of vehicle 200 (e.g., at least one device of autonomous system 202, at least one device of DBW system 202h, at least one device pf powertrain control system 204, at least one device of steering control system 206, and/or at least one device of brake system 208, and/or one or more devices of network 112 (e.g., one or more devices of a system of network 112). In some embodiments, one or more devices of vehicles 102 (e.g., one or more devices of a system of vehicles 102), at least one V2I device 110, at least one device of remote AV system 114, at least one device of fleet management system 116, at least one device of V2I system 118, at least one device of vehicle 200 (e.g., at least one device of autonomous system 202, at least one device of DBW system 202h, at least one device of powertrain control system 204, at least one device of steering control system 206, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

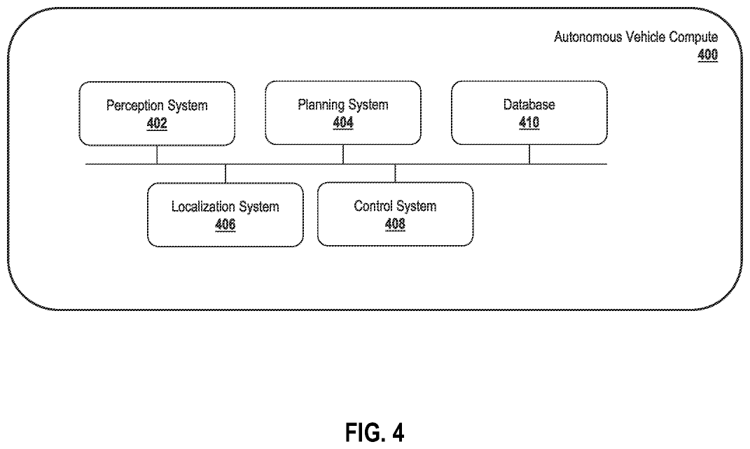

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects. The safety and performance of the perception system 402 can be improved by testing lens assemblies used therein according to the systems and methods for measuring optical vignetting described herein. Lens assemblies that are not of sufficient quality (e.g., exhibiting too much optical vignetting and some field positions) can be rejected for use in the perception system 402.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

As described above with reference to FIGS. 1-4, vehicles 102 can include autonomous systems 202 that can be configured to provide for different degrees of autonomous control of the vehicles 202. The autonomous systems 202 can make determinations based on inputs received from cameras 202a, which include lens assemblies (as well as from other types of inputs as well). To improve the safety and performance of such autonomous systems, use of lens assemblies of a sufficient degree of quality may be desirable.

As noted herein, for some lens assemblies, the aperture of the lens assembly can change at different field positions within the field of view of the lens assembly, for example, the aperture may decrease in size and/or change shape at field positions that move away from an on-axis (e.g., center) field position, resulting in a change of F-number at the various field positions. For some lens assemblies, this variation in the F-number can be quite large. This variation can occur for many reasons, including poor design of the lens assembly or use of low cost or imprecise lens elements within the lens assembly. This can lead to a large and undesirable performance drop for such lens assemblies, especially at field position of the outer field (e.g., greater than 0.5F). Accordingly, measuring optical vignetting and F-number at various field positions of lens assemblies that can be highly beneficial in ensuring quality and accuracy of the lens assemblies. This can be particularly true for lens assemblies that will be used in autonomous systems associated with vehicles, although other beneficial uses exist as well.

In general, measuring the F-number of a lens assembly or camera system is complicated and requires costly equipment, such as a Trioptics ImageMaster HR (300K). However, use of such equipment only provides for determination of an F-number associated with an on-axis field position (e.g., 0.0F). Prior to the systems, techniques and methodologies of the present application, no measurement tools or systems existed to measure an effective F-number at different field positions, including off-axis field positions.

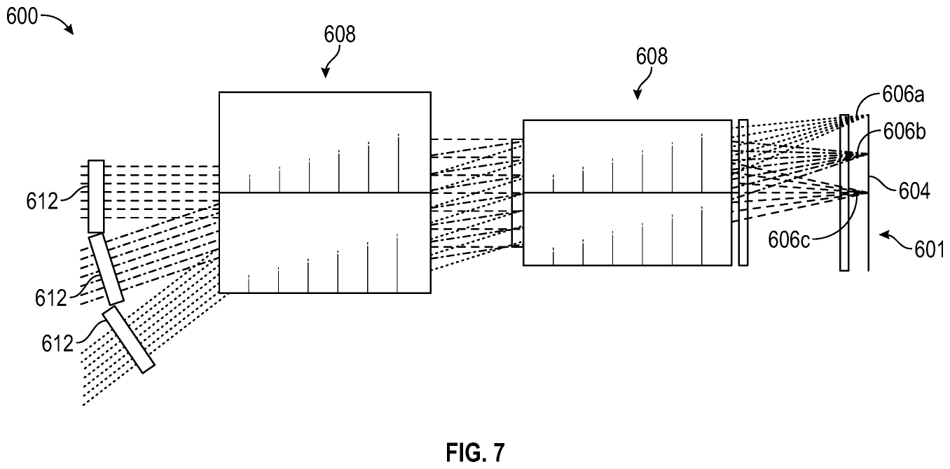

The problems associated with not being able to measure an effective F-number at different field positions can be resolved by using reverse projection of a light source through the lens assembly as described herein. In some implementations, the light source is positioned at the illumination at image plane of lens assembly. In some implementations, the light source comprises a selective vertical-cavity surface-emitting laser (VCSEL) array, although other light sources can also be used as well. The light source can be used to reverse project an aperture size at the object plane for measurement of an effective aperture size at each field positions using photosensor array as will be described in more detail below (e.g., with reference to FIGS. 7-11).

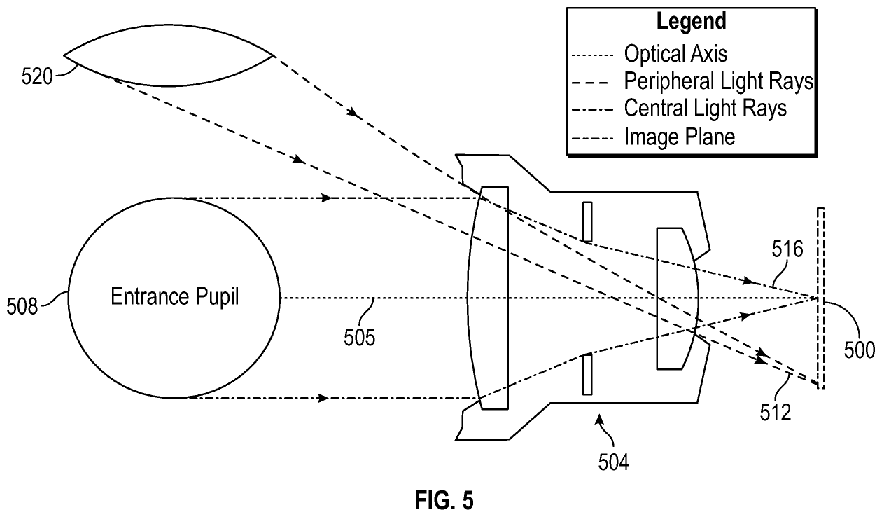

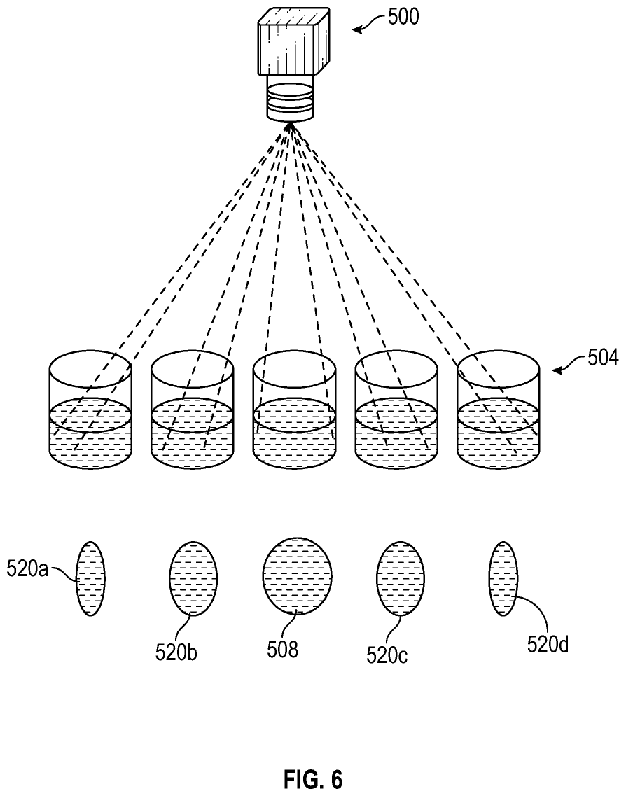

FIGS. 5 and 6 are diagrams depicting optical vignetting effects for a lens assembly or camera system at different field positions or viewing angles. Optical vignetting can be caused by light hitting a lens aperture at an angle with respect to the optical axis of the lens assembly. Various lens assembly design parameters, including internal physical obstructions within the lens assembly, can contribute to or cause optical vignetting. For lens assemblies that experience optical vignetting, the degree of optical vignetting is likely to be greater at outer field positions (e.g., positions that are off-optical axis to a greater degree) than inner field points (e.g., positions that are closer to the optical axis of the lens assembly).

Optical vignetting can negatively affect the performance of a camera system in an autonomous system (e.g., autonomous system 202). For example, optical vignetting can cause blind spots or reduced vision for the camera systems. Optical vignetting can also impact the vision range (e.g., field of view) of the camera systems and the performance of the camera systems in low light. The degree of optical vignetting can increase as the angle the light is hitting the lens increases relative to the optical axis of the lens. For example, see the reduction in light at the peripheral entrance pupils 520a, 520b, 520c, 520d in FIG. 6 discussed in more detail below.

FIGS. 5 and 6 illustrate examples of how the light passing through a lens assembly changes at different viewing angles. For example, as shown in FIGS. 5 and 6, the light that enters the lens assembly of a camera system can be reduced, due to optical vignetting, at field positions towards the outer field. A lens assembly with optical vignetting will increase this reduction of light at the outer field.

For example, FIG. 5 illustrates how the entrance pupil of a lens assembly changes at different viewing angles and generally reduces and changes shape at field positions moving from a central or on-axis field positions to more off-axis or far field positions. In FIG. 5, entrance pupil 508 illustrates the appearance of the entrance pupil for light traveling along the optical axis 505 of the lens assembly 504. As shown, the entrance pupil 508 is represented by a relatively large circular shape and there is no or minimal reduction in the light passing through the lens assembly 504 to an image sensor positioned at the image plane 500. In this example, central light rays 516 pass directly through the lens assembly 504 and reach the center of the image plane 500. In contrast, an illustrated peripheral light entrance pupil 520 is representative of light that enters the lens assembly 504 at an angle with respect to the optical axis 505 (e.g., at an off-axis field position, such as a far field position). As illustrated, a portion of the peripheral light from the entrance pupil 520 may be blocked by the lens assembly 504, for example by a lens barrel. The compressed or deformed oval of the peripheral entrance pupil 520 represents this loss in light when compared to the on-axis entrance pupil 508. The peripheral light rays 512 pass through the lens assembly 504 at an angle or off-axis position and reach an outer edge of the image plane 500. The decreased size and deformed shape of the peripheral light entrance pupil 520 is representative of optical vignetting.

The effects of optical vignetting are also shown in FIG. 6. For example, a central entrance pupil 508 aligned with the optical axis does not result in a reduction of light, as represented by the circular shape. In contrast, the peripheral entrance pupils 520a, 520b, 520c, 502d, showing the view of the camera through the optical system and corresponding to different off-axis field positions, show a reduction in light passing through the lens assembly or the optical system 504 at different viewing angles. As the viewing angle of the peripheral entrance pupil increases or widens the reduction in light passing through the lens assembly 504 increases. Thus, the optical vignetting at the off-axis positions the peripheral light passes through is likely to be greater. For example, more deformation or distortion is shown at peripheral entrance pupils 520a and 520d than at 520b and 520c.

The ability to measure the degree of optical vignetting at multiple field positions of a lens assembly, for example, as described herein, can provide for the ability to determine whether such a lens assembly should be rejected or accepted for use, for example, in the use of an autonomous system (e.g., autonomous system 202). This can be done to ensure that certain quality standards are maintained, improving the accuracy and safety of such an autonomous system.

FIG. 7 illustrates an example embodiment of a testing arrangement 600 that can be used to test various field positions of a lens or lens assembly (e.g., lens assembly 504) for optical vignetting and/or to measure an effective F-number of the lens or lens assembly at the various field positions. In the illustrated embodiment, the testing arrangement 600 includes a selective emitter array 604 (a light source), and one or more photo sensor arrays 612. As shown in FIG. 7, a lens assembly 608, which can include one or more lenses and/or other components, that is to be tested is also included.

Using the testing arrangement 600, light can be projected from the selective emitter array 604, through the lens assembly 608, and detected by the photo sensory array(s) 612. In general, and at a high level, during testing on the testing arrangement 600, light passes through the lens assembly 608 in the opposite direction than it would during general use of the lens assembly 608. For example, the selective emitter array 604 can be positioned at a location that generally corresponds to the image plane or focal plane of the lens assembly (e.g., at a position that an image sensor associated with the lens assembly 608 would normally be positioned), and the photo sensory array(s) 612 can be positioned at position(s) that generally correspond to different field positions within the field of view of the lens assembly 604.

Accordingly, in some instances, the testing arrangement 600 can be considered a reverse projection system because it projects light outwards through the lens where it is detected at different field positions. This is in contrast with how the lens assembly 608 would be generally used (e.g., light from different field positions would pass through the lens and be focused on an image sensor). By reverse projecting light through the lens assembly 608 and detecting that light with the photo sensor array(s) 612 at different field positions, the effects of optical vignetting at each of the field positions can be determined and measured.

For example, the testing arrangement can be configured to reverse project the aperture size of various field positions using selective illumination to illuminate any field position at the object side and measure the respective aperture size at different field angles by, for example, positioning the photo sensor array(s) 612 at the normal of the rays from the respective field angles. This can help to facilitate measurement of an effective F-number to ensure that the lens assembly 608 has consistent illumination throughout the field of view.

As shown in FIG. 7, the selective emitter array 604 can be configured to emit or reverse project beams of light, for example, beams of light 606a, 606b, 606c from different positions or angles through the lens assembly 608. Example selective emitter arrays 604 that can be used include but are not limited to OLED, LCD, or VSCEL arrays. In some implementations, the selective emitter array 604 can include photodiodes that can be illuminated to produce a beam of light that has enough divergence to cover the marginal ray at the widest field position of the lens assembly 608. This can, for example, allow the testing arrangement 600 to test all, nearly all, or most field positions of the lens assembly 608.

In some implementations, the testing arrangement 600 can be configured such that selective emitter array 604 can be activated such that all beams of light 606a, 606b, 606c, can be emitted at once through the lens assembly 608, or any variation of beams of light can be emitted, for example, one beam of light (e.g., 606a), two beams of light (e.g., 606a and 606b), or more, or any variation of the multiple beams of light 606a, 606b, 606c. While three exemplarily beams of light 606a, 606b, and 606c are depicted, any number may be projected from different angles from the selective emitter array 604. For example, one, two, three, four, five or more beams of light. Each individual beam of light 606a, 606b, 606c can initiate at a single point source and can be divergent.

The beam of light 606a, 606b, 606c that is activated can correspond to a specific or targeted field point of the lens assembly 608. The field point that the beam of light 606a, 606b, 606c passes through can be tested for optical vignetting using the methods described herein.

The photo sensor array 612 can be positioned normal or perpendicular to the beam of light 606a, 606b, 606c as transmitted through the lens assembly 608. This can be because, in some examples, automotive camera lenses are normally a finite to infinite conjugate, meaning that they are designed to be focused at infinity. Therefore, rays entering the lens are designed to be parallel rays at different field angles.

In some embodiments, one photo sensor array 612 can be used and positioned or moved according the beam of light 606a, 606b, 606c activated at the selective emitter array 604. In some embodiments, a corresponding number of photo sensor arrays 612 can be used to account for each beam of light 606a, 606b, 606c or field position being tested. For example, as shown in FIG. 7, there are three different beams of light 606a, 606b, 606c being tested and there are three photo sensor arrays 612 positioned normal or perpendicular to the reflected beams of light 606a, 606b, 606c after they pass through the lens assembly 608. In some embodiments, the photo sensor array 612 can exceed a size of the lens assembly 608.

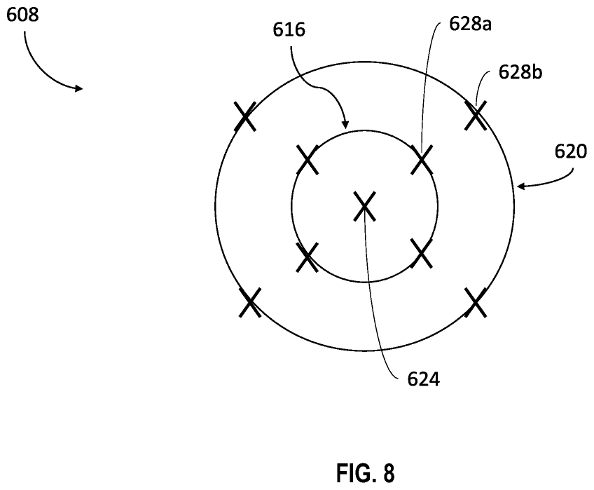

FIG. 8 is a diagram showing various example field positions of a lens assembly 608 to be tested for optical vignetting. The lens assembly 608 can have an inner field 616 (e.g., corresponding to field positions between 0.0F and 0.5F) and an outer field 620 (corresponding to field positions between 0.5F and 0.9F (or greater). It can be desirable to measure the effects at optical vignetting at various positions across the field of view of the lens assembly 608. For example, in FIG. 8, X's are positioned at example field positions where the effects of optical vignetting can be tested. In the illustrated example, an X is positioned on the optical axis 624, indicated that the lens assembly can be tested at a field position on the optical axis 624. Additionally, four X's 628a are positioned at different locations at the outer edges of the inner field 616 and four X's 628b are positioned at different locations at the outer edges of the outer field 620. In this example, FIG. 8 illustrates that nine field locations could be tested for optical vignetting. This, however, is only one example, and other numbers of field locations, and other field positions could be selected for testing.

In some methods of testing a lens assembly 608 for vignetting the field positions chosen can form an “X” across the lens, for example, as shown in FIG. 8. The selection of field points at these positions can ensure the on-optical axis field position is tested and that sufficient additional off-axis field positions across the lens assembly 608 are tested. While nine points field positions are depicted as being tested, in some embodiments a minimum of four field positions can be tested. For example, 4, 5, 6, 7, 8, 9, or more field positions can be tested. Any configuration of field positions can be tested. Therefore, the testing is not limited to the “X” pattern depicted in FIG. 8. In general, the greater number of field positions that are tested, the better the understanding of the optical vignetting of the lens assembly that is gained. Additionally, since optical vignetting is generally experienced at greater degrees, in some instances it is desirable to test at least some field positions corresponding to wide or far field of view positions.

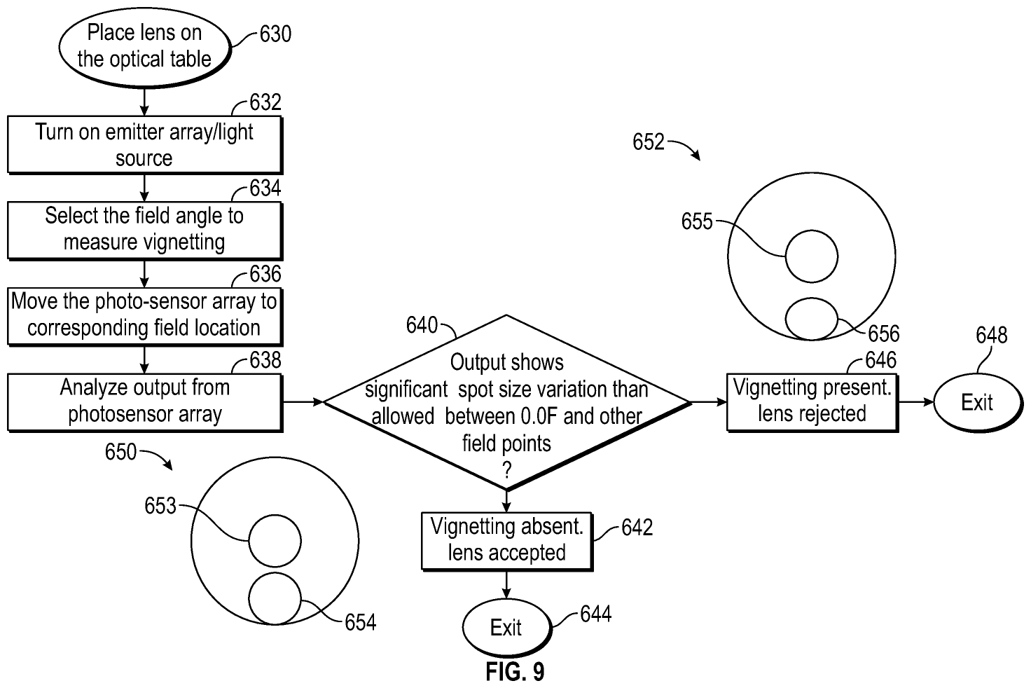

FIGS. 9-11 illustrate example methods or processes of testing a lens or lens assembly (e.g., lens assembly 608) for optical vignetting. The testing arrangements or setups 600 described above can be applied or used in any of the testing methods described herein.

Referring now to FIG. 9, illustrated is an example process for testing a lens or lens assembly (e.g., lens assembly 608) for optical vignetting. At block 630, the lens or lens assembly (e.g., lens assembly 608) is positioned on the optical table. As described above, with reference to FIG. 7, the lens assembly 608 can be positioned between the selective emitter array 604 and the photo sensor array 612.

Moving to block 632, the selective emitter array 604 or light source can be turned on or activated. As described with reference to FIG. 7, selective emitter array 604 can be activated such that a beam of light is reverse projected through the lens assembly 604 at a position corresponding to a desired field position at which it is desired to measure optical vignetting. For example, at block 634, the field angle or field position of the lens assembly can be selected for measuring optical vignetting. In some embodiments, this may be determined by turning on a specific source of light from the selective emitter array 604. For example, with reference to FIG. 7, beams of light 606a can be turned on while beams of light 606b and 606c are turned off. In other embodiments, more than one beam of light can be turned on at once. For example, all three beams of light 606a, 606b, and 606c can be turned on for testing. The beams of light activated can be determined based on the field position to be tested.

Moving to block 636, the photo sensor array 612 can be moved to or positioned at the corresponding field position. As described herein, the photo sensor array 612 can be positioned normal or perpendicular to the beams of light as reflected through the lens. In some embodiments, a corresponding number of photo sensor arrays 612 to beams of light may be used. In some embodiments, the photo sensor array 612 can be physically moved depending on the field position of the lens assembly being tested.

Moving to block 638, the output from the photo sensor array 612 can be analyzed. In some embodiments, the photo sensor array can detect a spot of light that results from the beam of light reverse projected through the lens assembly 608. Analysis of the output of the photo sensor array 612 can include determining the size and/or shape of the spot of light detected by the photo sensor array 612 (referred to herein as the spot size). The detected spot size can be, for example, compared with an on-axis spot size (e.g., a spot-size corresponding to a field position on the optical axis of the lens assembly), and deviations from the on-axis spot size can be representative of the presence of optical vignetting.

In some embodiments, the output can be analyzed to determine the effective F-number at the various field positions or angles of the lens. Equations 1-3, shown below, can be used to determine the effective F number.

Effective F-Number=EFL/(((FA/OA)×A×4/π)²) Equation 1:

Effective F-Number=EFL/Deq Equation 2:

Deq=(((FA/OA)×A×4/π)²) Equation 3:

In equations 1-3 above, “EFL” can represent the effective focal length. The effective focal length is the distance between the rear principal point and the rear focal point of a lens. “A” can represent the area of the entrance pupil. “OA” can represent the area of the on-axis spot. “FA” can represent the area of the off-axis spot. “Deq” can represent the equivalent diameter. The effective focal length and the area of the entrance pupil can be fixed values determined by the lens or lens assembly being tested. The on-axis spot size and the off-axis spot sized can be determined through the testing methods described herein.

Moving to block 640, the output can be reviewed to determine if there is significant spot size variation. If the spot size variation is below an accepted threshold the user can move to block 642. If the spot size variation is above an accepted threshold the user can move to block 646. The spot size of the field position being tested can be compared to the on-axis spot and/or other field positions being tested. In some methods of testing a variation less than 1%, less than 2.5%, less than 5%, less than 10%, less than 15%, less than 20%, or less than 25%, from the on-axis spot can be considered an acceptable variation. The acceptable threshold can vary based on the user's requirements and the end use of the lens. For example, some uses of the lens may require a stricter threshold (i.e., less optical vignetting), whereas other uses may allow for more optical vignetting without rejecting a lens. In some methods of testing, the spot size can be compared to a set F-number and range performance. The lens can be accepted if the spot size does not exceed the maximum F-number and if the spot size does not fall short of the minimum range requirements.

Moving to block 642, if optical vignetting is absent or below the threshold described above the lens assembly can be accepted (e.g., used in an autonomous system for a vehicle). Before a lens assembly can be accepted and the testing completed at block 644, the lens can be tested at multiple field points to ensure all field points being tested fall within the acceptable parameters. For example, with reference to FIG. 8, all nine field points can go through the testing process prior to accepting the lens. Diagram 650 represents an acceptable lens. As shown, the on-axis spot 653 and the off-axis spot 654 show no optical vignetting or optical vignetting below the required threshold. As shown, there is no deformation or compression to the circle representing the off-axis spot 654.

Moving to block 646, if optical vignetting is detected and above the acceptable threshold the lens assembly can be rejected, and the testing completed at block 648. If one field point indicates optical vignetting requiring rejection of the lens assembly, the testing can be completed, and the lens assembly rejected without the need to test all planned field points. However, in some embodiments, the user or system can proceed with testing the remaining field points for optical vignetting by repeating the method. Diagram 652 represents a rejectable lens assembly according to an embodiment. As shown, the off-axis spot 656 shows optical vignetting above the required threshold. As shown, there is deformation or compression of the spot circle representing the off-axis spot 656 as compared to the on-axis spot 655.

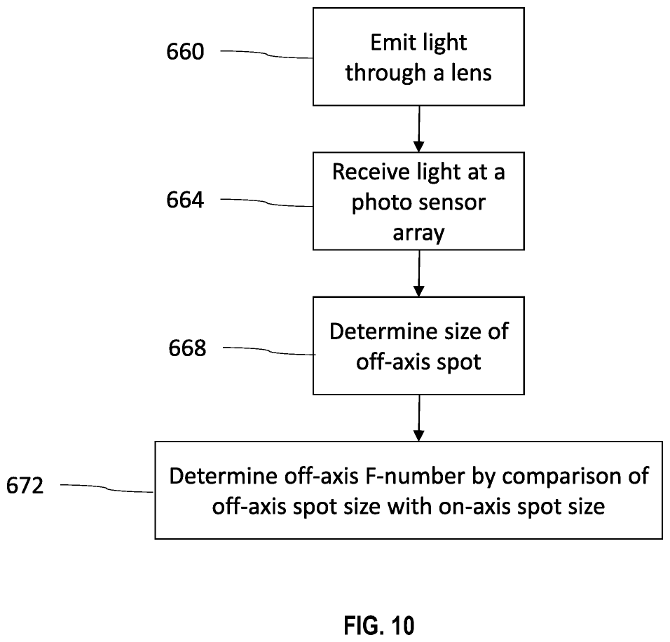

Referring now to FIG. 10, illustrated is another example method of testing a lens or lens assembly (e.g., lens assembly 608) for optical vignetting. Starting at block 660 light can be emitted through a lens or a lens assembly. The light can be emitted using a selective emitter array (e.g., selective emitter array 604). The angle of the light can be determined based on the field position of the lens that will be tested. The emission of light can be reverse projected through the lens assembly. The light can be emitted such that after passing through the lens assembly, the light exits the lens along a trajectory corresponding to a field position at which testing for optical vignetting is desired.

Moving to block 664, the light emitted through the lens can be received at a photo sensor array (e.g., photo sensor array 612). As described herein, the photo sensor array can be positioned normal or perpendicular to the light being received.

Moving to block 668, the size of the off-axis spot can be determined based on the light received by the photo sensor array.

Moving to block 672, the off-axis F-number can be determined by comparing the off-axis spot size with the on-axis spot size. For example, Equations 1-3 described above can be used to determine the off-axis F-number.

This method or process can be repeated to test the various field positions of the lens.

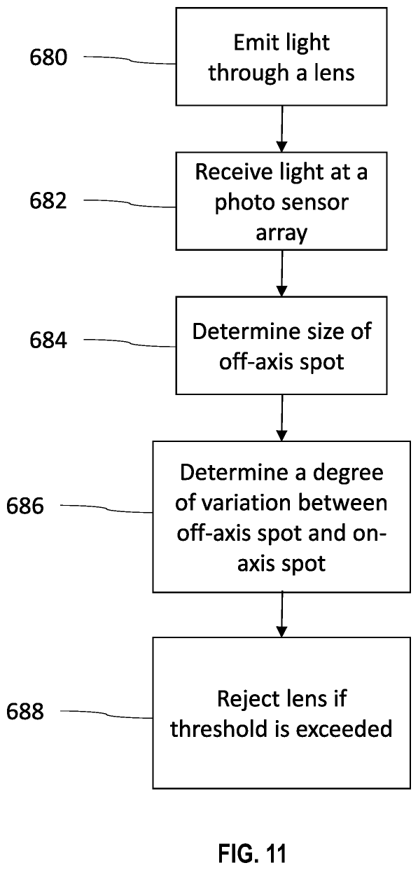

Referring now to FIG. 11, illustrated is another example method of testing a lens or lens assembly (e.g., lens 608) for optical vignetting. Starting at block 680, light can be emitted through a lens or a lens assembly. The light can be emitted using a selective emitter array (e.g., selective emitter array 604). The angle of the light can be determined based on the field position of the lens that will be tested.

Moving to block 682, the light emitting through the lens can be received at a photo sensor array. As described herein, the photo sensor array can be positioned normal or perpendicular to the light being received.

Moving to block 684, the size of the off-axis spot can be determined based on the light received by the photo sensor array.

Moving to block 686, a degree of variation between the off-axis spot and the on-axis spot can be determined. For example, Equations 1-3 described above can be used to determine the variation or effective F-number of the off-axis spot.

Moving to block 688, the lens can be rejected if an acceptable threshold of variation is exceeded. If the field position being tested does not result in the lens being rejected, the method can be repeated for other field points of the lens.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A method, comprising:
causing a selective emitter array to emit at least one beam of light through an off-optical axis field position of a lens assembly;
receiving, at a photo sensor array, an off-axis spot based at least in part on the emitted at least one beam of light;
determining a size of the off-axis spot; and
determining an off-axis F-Number of the lens assembly associated with the off-optical axis field position based on comparing the determined size of the off-axis spot with a size of an on-axis spot.

2. The method of claim 1, wherein the on-axis spot corresponds to a spot determined from emitting at least on beam of light through the optical axis of the lens.

3. The method of claim 1, wherein the off-axis F-Number is determined at more than one off-axis field position.

4. The method of claim 1, wherein the photo sensor array is moveable.

5. The method of claim 1, wherein the photo sensor array is positioned normal to the at least one beam of light.

6. The method of claim 1, wherein the photo sensor array exceeds a size of the lens assembly.

7. The method of claim 1, wherein more than one beam of light is emitted through the off-optical axis field position of a lens.

8. A method, comprising:
causing a selective emitter array to emit at least one beam of light through an off-optical axis field position of a lens assembly;
receiving, at a photo sensor array, an off-axis spot based at least in part on the emitted at least one beam of light;
determining a size of the off-axis spot;
determining a degree of variation between the determined size of the off-axis spot and a size of an on-axis spot of the lens assembly; and
rejecting the lens assembly based on determining that the degree of variation exceeds a threshold.

9. The method of claim 8, wherein the on-axis spot corresponds to a spot determined from emitting at least on beam of light through the optical axis of the lens.

10. The method of claim 8, wherein the degree of variation is determined at more than one off-axis field position.

11. The method of claim 8, wherein the photo sensor array is moveable.

12. The method of claim 8, wherein the photo sensor array is positioned normal to the at least one beam of light.

13. The method of claim 8, wherein the photo sensor array exceeds a size of the lens assembly.

14. The method of claim 8, wherein more than one beam of light is emitted through the off-optical axis field position of a lens.

15. A system, comprising:
at least one processor; and
at least one memory storing instructions thereon that, when executed by the at least one processor, cause the at least one processor to:
cause a selective emitter array to emit at least one beam of light through an off-optical axis field position of a lens assembly;
receive, at a photo sensor array, an off-axis spot based at least in part on the emitted at least one beam of light;
determine a size of the off-axis spot; and
determine an off-axis F-Number of the lens assembly associated with the off-optical axis field position based on comparing the determined size of the off-axis spot with a size of an on-axis spot.

16. The system of claim 15, wherein the on-axis spot corresponds to a spot determined from emitting at least on beam of light through the optical axis of the lens.

17. The system of claim 15, wherein the off-axis F-Number is determined at more than one off-axis field position.

18. The system of claim 15, further comprising the photo sensor array and the selective emitter array.

19. The system of claim 15, wherein the photo sensor array is positioned normal to the at least one beam of light.

20. The system of claim 15, wherein more than one beam of light is emitted through the off-optical axis field position of a lens.
